(19) United States
(12) Patent Application Publication
(10) Pub. No.: US 2009/0104818 A1
(43) Pub. Date: Apr. 23, 2009

(54) Card edge connector with improved latch member

(75) Inventors: Ren-Fu Wu, Kunshan (CN); Wen-Jun Tang, Kunshan (CN); Xue-Wu Bu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECESION IND. CO., LTD.

(21) Appl. No.: 12/288,531

(22) Filed: Oct. 20, 2008

(30) Foreign Application Priority Data
Oct. 19, 2007 (CN) 200720043779.0

(51) Int. Cl. H01R 33/00

(52) U.S. Cl. 439/638

(57) ABSTRACT

A card edge connector includes an elongated insulative housing and a plurality of contacts retained in the insulative housing. The insulative housing includes a mounting surface and a mating surface defining an elongated slot for receiving a daughter PCB. Each contact has a contacting portion extending into the elongated slot and a clip portion for clipping a mother PCB. The insulative housing further includes two pairs of elastic arms integrally extending from lateral sides thereof. Each elastic arm includes a protrusion for stably abutting against the mother PCB.

### FIELD OF THE INVENTION

The present invention is related to a card edge connector, and particularly to a card edge with improved latch member for mounting a printed circuit board (PCB).

### DESCRIPTION OF RELATED ART

U.S. Pat. No. 5,160,275 discloses a card edge connector including a main body and a plurality of contacts retained in the main body according to the first embodiment thereof. The main body includes a mating portion and two pairs of extensions protruding backwardly from the mating portion with a receiving cavity disposed between the two pairs of extensions. Each extension includes a protrusion on its inner surface. The protrusion extends into the receiving cavity for abutting against a mother PCB so that the mother PCB can be retained in the receiving cavity. However, the extensions have large width such that they have weak elasticity. When the mother PCB is inserted into the receiving cavity, the extensions can't provide enough deformation in order to clip the mother PCB.

Another card edge connector is disclosed according to the second embodiment of U.S. Pat. No. 5,160,275. The another card edge connector includes a main body and a plurality of contacts retained in the main body. The mating portion defines a slot for receiving a daughter PCB. Each extension includes a slit communicating with the receiving cavity. The contacts include contact portions extending into the slot for mating with a daughter PCB, and clip portions extending into the receiving cavity mating with the mother PCB. In order to firmly retain the mother PCB, the card edge connector further includes a frame member received in slit and the receiving cavity of the main body. The frame member includes two pairs of retaining arms defining a receiving slit. Each pair of retaining arms include a pair of protrusions extending into the receiving slit in condition that, when the mother PCB is received in the slit, the protrusions can abut against through holes of the mother PCB for retaining purpose. However, the another card edge connector has to include two members combined together for retaining the mother PCB, it makes the another card edge connector have a complex structure and inconveniently in assembly.

Hence, an improved card edge connector is required to overcome the disadvantages of the prior art.

### BRIEF SUMMARY OF THE INVENTION

Accordingly, an object of the present invention is to provide a card edge connector with simple structure and having improved elastic arms for retaining a mother PCB.

In order to obtain the object, a card edge connector for electrically connecting a daughter PCB and a mother PCB comprising an insulative housing extending along an elongated direction. The insulative housing comprise a main portion and two pairs of elastic arms integrally extending from two lateral sides of the main portion. The main portion includes a mounting surface and a mating surface opposite to the mounting surface. An elongated slot recessed from the mating surface for receiving the daughter PCB. Each pair of elastic arms extend beyond the mounting surface and comprise an upper arm and a lower arm with a slit disposed therebetween. A receiving space is disposed communicating with the slit for corporately receiving the mother PCB. Each arm includes a protrusion extending into the slit for retaining the mother PCB. The card edge connector includes a plurality of contacts retained in the main portion. The contacts comprises contact portions protruding into the elongated slot for abutting against the daughter PCB, and clip portions extending beyond the mounting surface of the main portion to extend into the receiving space for abutting against the mother PCB.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a card edge connector with a mother PCB received therein according to a preferred embodiment of the present invention;

FIG. 2 is a rear perspective view of the card edge connector;

FIG. 3 is an exploded view of the card edge connector shown in FIG. 1 before insertion of the mother PCB;

FIG. 4 is an another exploded view of the card edge connector shown in FIG. 1, but viewed from anther aspect;

FIG. 5 is a side view of the card edge connector and the mother PCB shown in FIG. 1; and

FIG. 6 is a cross-sectional view of the card edge connector taken along the line 6-6 of FIG.2.

### DESCRIPTION OF THE PREFERRED EMBODIMENT

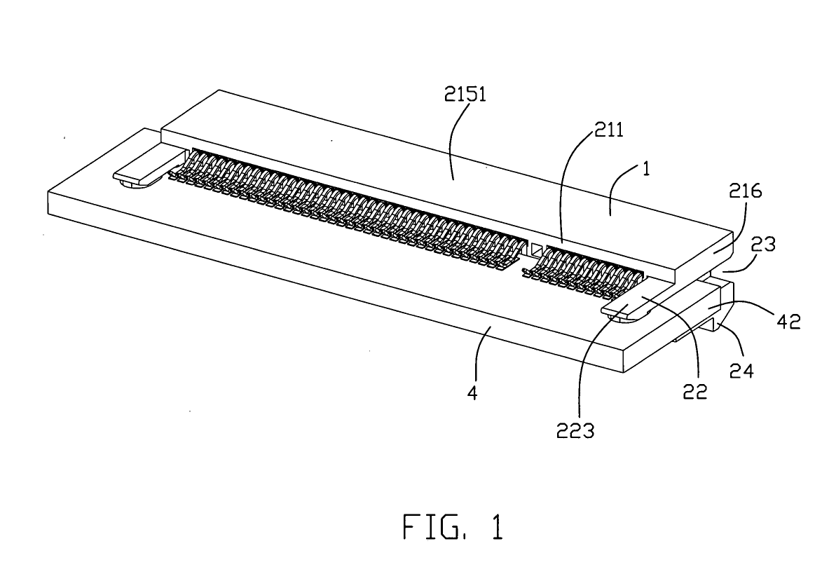

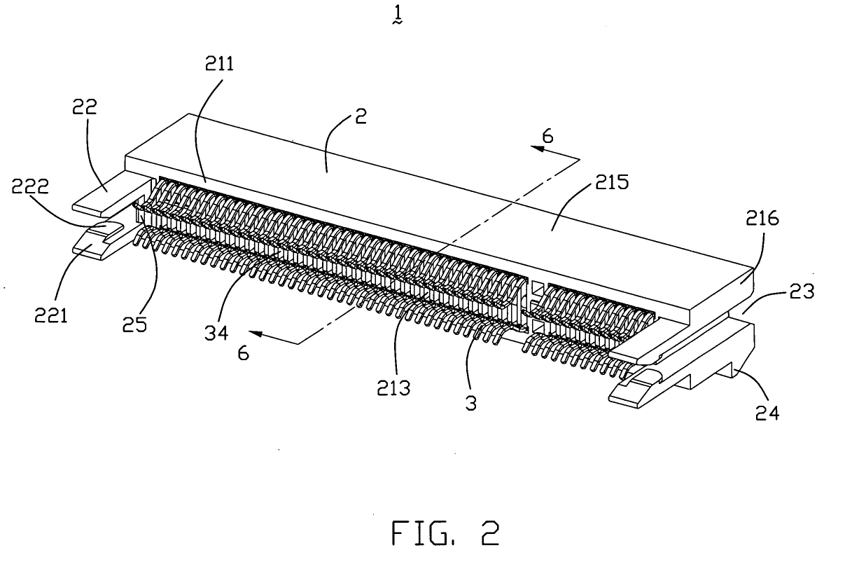

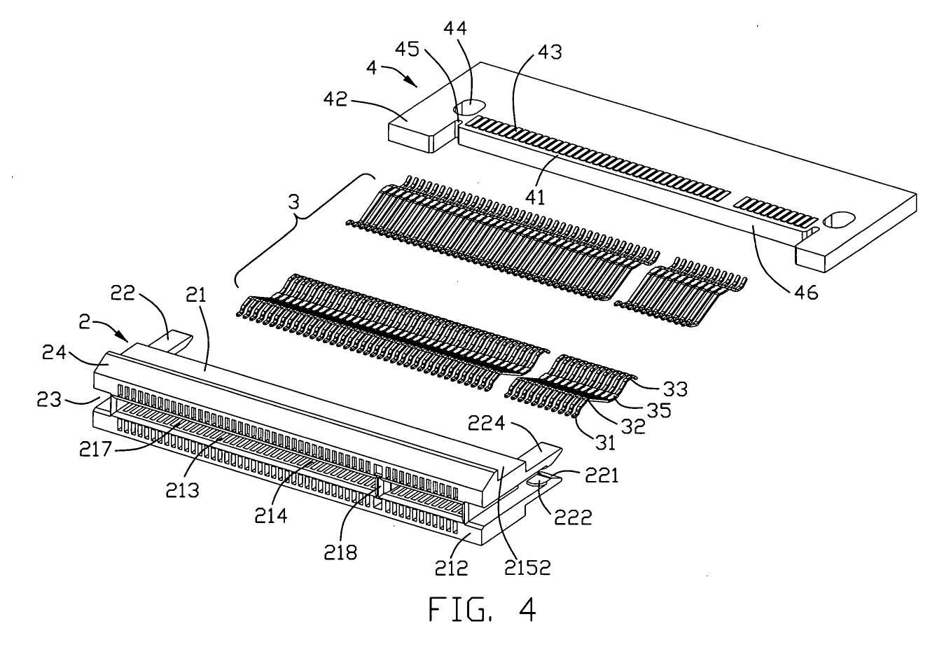

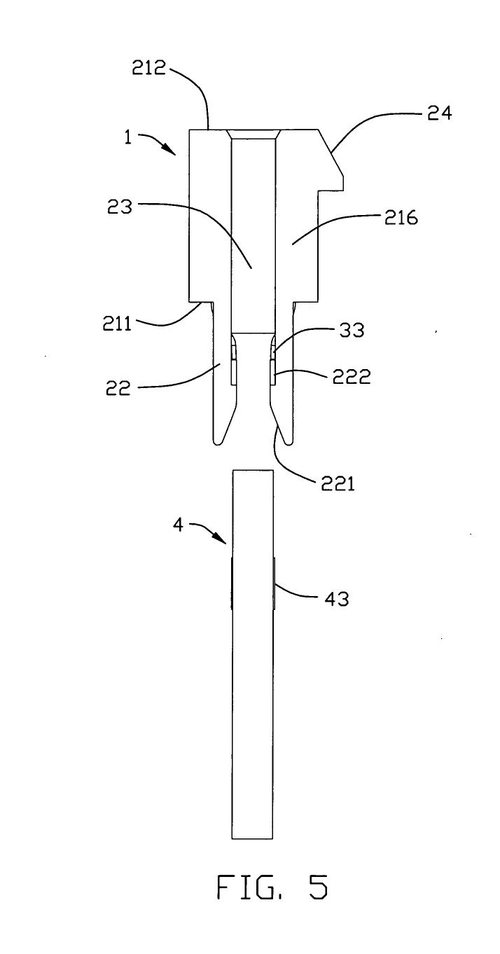

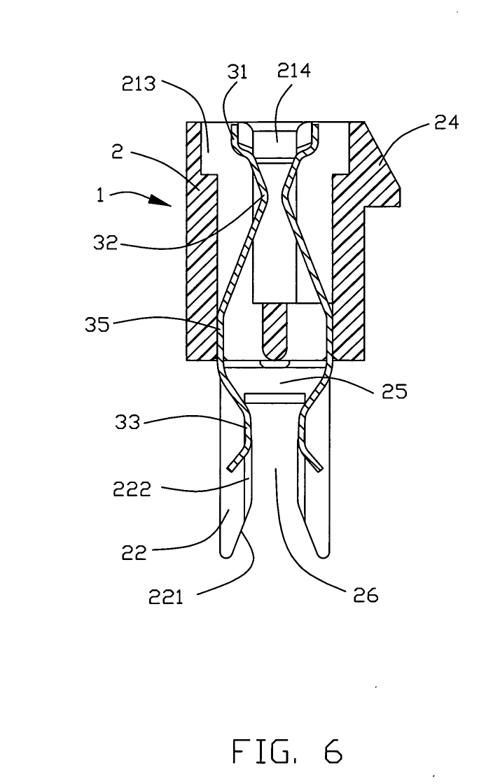

Referring to FIGS. 1-6, a card edge connector 1 according to a preferred embodiment of the present invention is disclosed. The card edge connector 1 is mounted on a mother PCB 4 for receiving a daughter PCB (not shown). The mother PCB 4 includes an inserting portion 41 and two retaining portions 42 which horizontally extend from two lateral sides of the inserting portion 41. Each retaining portion 42 defines a through hole 44. The inserting portion 41 has a plurality of golden fingers 43 on its opposite sides thereof. The mother PCB 4 further defines an inserting surface 46 and a pair of depressions 45 recessed from the inserting surface 46 at corners connected by the retaining portion 42 and the inserting portion 41.

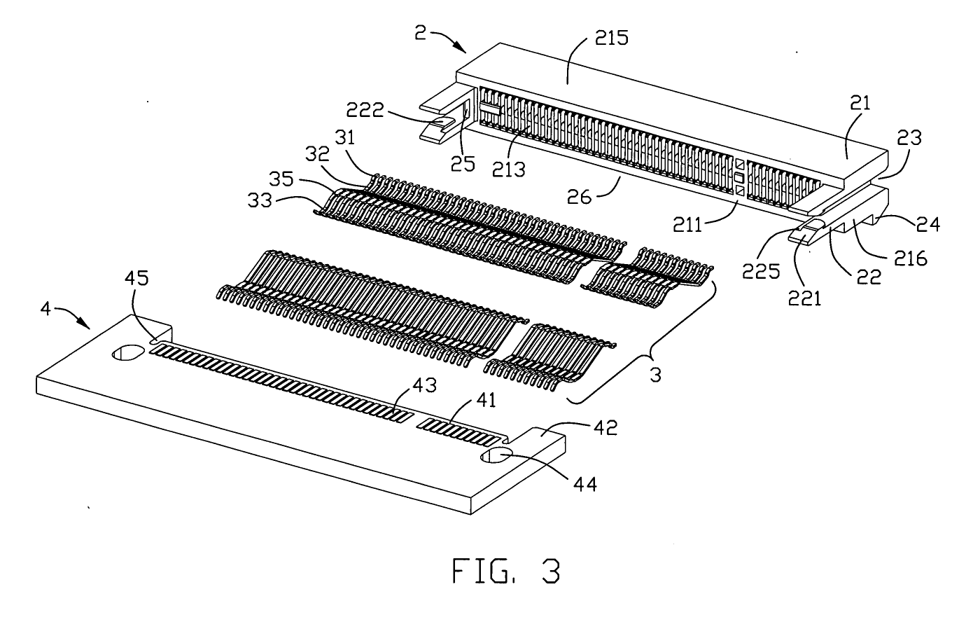

Referring to FIG. 3, the card edge connector 1 includes an insulative housing 2 and a plurality of contacts 3 received in the insulative housing 2. The insulative housing 2 includes a main portion 21 and first and second pairs of elastic arms 22 integrally extending from two lateral sides of the main portion 21. A receiving space 26 is formed between the first and the second pairs of elastic arms 22. Each pair of elastic arms 22 include an upper arm and a bottom arm with a slit 23 disposed therebetween. The slit 23 is in communication with the receiving space 26 to corporately receive the mother PCB 4. The main portion 21 has a mating surface 212 defining an elongated slot 214 for receiving the daughter PCB, a mounting surface 211 opposite to the mating surface 212, two lateral side surfaces 216 at the side of the insulative housing 2, and two main side surfaces 215 which are perpendicular to the lateral side surfaces 216 and parallel to the mother PCB 4. The elongated slot 214 extends along an elongated direction of the insulative housing 2. The slit 23 further extends over the mounting surface 211 along a transverse direction perpendicular to the elongated direction in order to receive the retaining portion 42 of the mother PCB 4. The main side surfaces 215 include a top surface 2151 and a bottom surface 2152 opposite to the top surface 2151. The upper arm has another top surface 223 lower than the top surface 2151 of the main portion 21. The lower arm has another bottom surface 224 above the bottom surface 2152 of the main portion 21. As a result, the elastic arms 22 can have enough elasticity to provide enough deformation in order to clip the mother PCB 4. The elongated slot 214 is depressed from the center of the mating surface 214 for receiving the daughter PCB. The main portion 21 has a plurality of grooves 213 depressed from the mating surface 214 at the two sides of the elongated slot 214 for receiving the contacts 3. The grooves 213 communicate with the two side surfaces 217 of the elongated slot 214. The elongated slot 214 comprises two parts which have different length separated by a rib 218. When the daughter PCB is inserted into the elongated slot 214, the rib 218 is received in a notch (not shown) in order that the daughter PCB can't be wrongly inserted into the elongated slot 214.

Correspondingly, referring to FIGS.3-6, each elastic arm 22 has a distal end opposite to the main portion 21. Each distal end includes a slant wall 221 communicating with the slit 23 for guiding insertion of the mother PCB 4. Each elastic arm 22 includes a clipping surface 225 at two sides of the slit 23. The clipping surface 225 is parallel to the main side surfaces 215. Each elastic arm 22 has a protrusion 222 extending from the clipping surface 225 and connecting with the slant wall 221 substantially. Each protrusion 222 comprises an arc surface on an inner side thereof for being received in the through hole 44 of the mother PCB 4. As a result, the elastic arms 22 can retain the mother PCB 4 firmly. The insulative housing 2 includes two clapboards 25 in the two slits 23, respectively. The clapboards 25 extend from the mounting surface 211 for being received in the depressions 45 of the mother PCB 4 in order to position the mother PCB 4. The main portion 21 has an elongated wedge 24. A split arrow device (not shown) can be used to clip the wedge 24 when the daughter PCB is mounted to the card edge connector 1 in order that the daughter PCB can be stably mounted thereto.

Referring to FIG. 3, the contacts 3 include fixing portions 35 retained in the insulative housing 2, clip portions 33 extending beyond the mounting surface 211 of the main portion 21 and further extending into the receiving space 26, contact portions 32 protruding into the elongated slot 214 for abutting against the daughter PCB, and bend portions 31 extending from the contact portions 32. The clip portions 33 are arranged in two rows to form a long groove 34 therebetween for receiving the mother PCB 4. The long groove 34 extends along the elongated direction of the main portion 21 and communicates with the slits 23 to corporately receive the mother PCB 4. The thickness of the long groove 34 is smaller than the thickness of the mother PCB 4 in order to clip the mother PCB 4 effectively. The contact portions 32 extends into the elongated slot 214 to contact the golden fingers (not shown) of the daughter PCB. The clip portions 33 extend out of the mounting surface 211 of the main portion 21 to contact the golden fingers 43 of the mother PCB 4. As a result, the card edge connector 1 can electrically connects the mother PCB 4 and the daughter PCB.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A card edge connector for electrically connecting a daughter PCB and a mother PCB, comprising:
an insulative housing extending along an elongated direction and comprising a main portion and a first pair of elastic arms integrally extending from a lateral side of the main portion, the main portion including a mounting surface and a mating surface opposite to the mounting surface with an elongated slot recessed from the mating surface for receiving the daughter PCB, the first pair of elastic arms extending beyond the mounting surface and comprising an upper arm and a lower arm with a slit disposed therebetween, a receiving space communicating with the slit for corporately receiving the mother PCB, the upper or the lower arm including a protrusion extending into the slit for retaining the mother PCB; and
a plurality of contacts retained in the main portion, the contacts comprising contact portions protruding into the elongated slot for abutting against the daughter PCB, and clip portions extending beyond the mounting surface of the main portion to extend into the receiving space for abutting against the mother PCB.

2. The card edge connector as claimed in claim 1, wherein the slit further extends over the mating surface along a transverse direction perpendicular to the elongated direction.

3. The card edge connector as claimed in claim 1, wherein the upper and the lower arms each is provided with the protrusion.

4. The card edge connector as claimed in claim 1, wherein the upper and the lower arms including distal ends opposite to the main portion, each distal end including a slant wall communicating with the slit for guiding insertion of the mother PCB.

5. The card edge connector as claimed in claim 4, wherein the protrusion substantially connecting with the corresponding slant wall.

6. The card edge connector as claimed in claim 4, wherein the protrusion comprises an arc surface on an inner side thereof for mating with the mother PCB.

7. The card edge connector as claimed in claim 1, wherein the insulative housing comprises a second pair of elastic arms integrally extending from another lateral side of the main portion with the receiving space located between the first and the second pair of elastic arms along the elongated direction.

8. The card edge connector as claimed in claim 1, wherein the main portion defines a plurality of grooves on two sides of the elongated slot and communicating with the elongated slot, the contact portions being received in the grooves and extending into the elongated slot.

9. The card edge connector as claimed in claim 1, wherein the main portion includes a top surface, the upper arm having another top surface lower than the top surface.

10. The card edge connector as claimed in claim 9, wherein the main portion comprises a bottom surface opposite to the top surface, the lower arm having another bottom surface above the bottom surface.

11. A card edge connector assembly, comprising:
a PCB comprising an inserting portion and two retaining portions extending from two lateral sides of the inserting portion, the inserting portion including a plurality of golden fingers on its opposite sides thereof, the retaining portions extending beyond an inserting surface of the inserting portion; and
a card edge connector comprising:
an insulative housing extending along an elongated direction, the insulative housing comprising a main portion and two pairs of elastic arms integrally extending from opposite lateral sides of the main portion, the main portion including a mounting surface beyond which the two pairs of elastic arms extend, a receiving space being formed between the two pairs of elastic arms, each pair of elastic arms extending beyond the mounting surface and comprising an upper arm and a lower arm with a slit disposed therebetween, the slit extending over the mounting surface and further extending into the main portion to receive the retaining portions of the PCB, the slit being in communication with the receiving space to corporately receive the PCB, the upper or the lower arm including a protrusion extending into the slit to abut against the PCB; and
a plurality of contacts retained in the main portion, the contacts comprising contact portions for abutting against another PCB and clip portions cantileveredly extending beyond the mounting surface of the main portion to abut against the golden fingers of the PCB.

12. The card edge connector assembly as claimed in claim 11, wherein the slit extends along a transverse direction perpendicular to the elongated direction.

13. The card edge connector assembly as claimed in claim 11, wherein the main portion defines a through hole to abut against the protrusion.

14. The card edge connector assembly as claimed in claim 11, wherein the main portion comprises a mating surface opposite to the mounting surface with an elongated slot recessed from the mating surface, the contact portions protruding into the elongated slot for receiving another PCB.

15. The card edge connector assembly as claimed in claim 11, wherein the main portion includes a top surface and a bottom surface opposite to the top surface, the upper arm having another top surface lower than the top surface, and the lower arm having another bottom surface above the bottom surface.

16. The card edge connector assembly as claimed in claim 11, wherein the insulative housing comprises a clapboard extending into the slit, the PCB defining a depression recessed from the inserting surface to receive the clapboard.

17. A card edge connector assembly comprising:
an insulative elongated housing defining a central slot extending along a longitudinal direction thereof;
a pair of retention towers respectively formed on two opposite ends of the housing,
each of said retention towers including a pair of opposite elastic arms spaced from each other, with a gap, in a transverse direction perpendicular to said longitudinal direction, at least one of said elastic arms being equipped with a protrusion toward the other, and a slit formed in a corresponding end section of housing in alignment with the gap of the corresponding elastic arms;
two rows of terminals disposed in the housing with contacting portions exposed in the central slot and mounting portions behind a rear face of the housing and between the pair of retention towers;
a printed circuit board defining an inserting portion sandwiched between said two rows of terminals behind the rear face of the housing, and two opposite retention portions by two sides of the inserting portion along the longitudinal direction; wherein
the retention portion is sandwiched by the corresponding pair of elastic arms and essentially located within the corresponding gap and the corresponding slit.

18. The card edge connector assembly as claimed in claim 17, wherein said printed circuit board further includes a pair of through holes adjacent to the corresponding retention portions to receive the corresponding protrusions therein, respectively.

19. The card edge connector assembly as claimed in claim 17, wherein a notch is formed between each of the retention portion and the inserting portion to receive a corresponding clapboard which extends rearwardly from a root region of the corresponding pair of elastic arms.

20. The card edge connector assembly as claimed in claim 17, wherein the retention portion terminates before reaching a front face of the housing.
